(19) United States
(12) Patent Application Publication
(10) Pub. No.: US 2011/0318062 A1
(43) Pub. Date: Dec. 29, 2011

(54) Developer Conveying Device and Development Device, Toner Cartridge, and Cleaning Unit that are Provided with Developer Conveying Device

(76) Inventors: Shigeki HAYASHI, Osaka (JP); Takafumi Nagai, Osaka (JP)

(21) Appl. No.: 13/164,035

(22) Filed: Jun. 20, 2011

(30) Foreign Application Priority Data
Jun. 23, 2010 (JP) 2010-142826

(51) Int. Cl. G03G 15/08; G03G 21/00

(52) U.S. Cl. 399/254; 399/258; 399/358

(57) ABSTRACT

A developer conveying device comprising: a developer conveying cylinder; and a screw-shaped shaft, wherein the screw-shaped shaft includes a rotating shaft that is journaled in an upstream wall portion and a downstream wall portion, which are included in the developer conveying cylinder, and a spiral blade that is mounted on an outer circumferential surface of the rotating shaft; the rotating shaft includes a conical portion that thickens gradually toward the downstream side; and the spiral blade includes an agitating blade portion whose lead angle increases gradually toward the downstream side.

### CROSS-REFERENCE TO RELATED APPLICATION

This application is related to Japanese patent application No. 2010-142826 filed on Jun. 23, 2010 whose priority is claimed under 35 USC §119, the disclosure of which is incorporated by reference in its entirety.

### BACKGROUND OF THE INVENTION

1. Field of the Invention

The present invention relates to a developer conveying device that conveys a developer containing at least a toner, and a development device, a toner cartridge, and a cleaning unit which are provided with the developer conveying device.

2. Description of the Related Art

Recently a two-component developer (hereinafter simply referred to as “developer”) having excellent toner charging stability is widely used in an electrophotographic image forming apparatus that meets a full-color image and a high-quality image. The developer includes a toner and a carrier. When the developer is agitated in a developer tank of a development device, a properly-charged toner is obtained by friction between the toner and the carrier. In the development device, the charged toner is supplied to a surface of a development roller, and the charged toner is moved to an electrostatic latent image formed on a photoconductive drum from the development roller by an electrostatic suction power. Therefore, a toner image is formed on the photoconductive drum based on the electrostatic latent image.

Additionally, there is a demand for a high-speed, miniaturized image forming apparatus. Therefore, it is necessary to quickly and sufficiently charge the developer, and also to quickly transfer the developer. For example, Japanese Patent Application Laid-Open No. 2001-255723 proposes a cycling type development device including first and second developer conveyance paths that are divided by a partition plate provided in the developer tank, first and second communication paths that communicate the first developer conveyance path and the second developer conveyance path on both end sides, and first and second auger screws that are disposed in the first and second developer conveyance paths to mutually convey the developer in opposite directions.

In a configuration of the development device of Japanese Patent Application Laid-Open No. 2001-255723, the developer conveyed onto the downstream side of a first developer conveyance path by the first auger screw is pushed out from the first communication path to the second developer conveyance path along an inside wall surface of the developer tank by a pressure generated between the developer conveyed from the upstream side of the first developer conveyance path and the developer that has nowhere to go in front of the developer tank inside wall, and the developer conveyed onto the downstream side of a second developer conveyance path by the second auger screw is pushed out from the second communication path to the first developer conveyance path along an inside wall surface of the developer tank by a pressure generated between the developer conveyed from the upstream side of the second developer conveyance path and the developer that has nowhere to go in front of the developer tank inside wall, whereby the developer is cycled between the first developer conveyance path and the second developer conveyance path.

In the development device of Japanese Patent Application Laid-Open No. 2001-255723, it is necessary for the developer to change a traveling direction at a right angle in a position where the developer faces the communication path in a downstream end part of the auger screw. However, the developer is pushed out only in a rotating shaft direction by rotation of the auger screw. Therefore, the developer has nowhere to go due to the developer tank inside wall, and the developer existing near a corner part of the developer tank is compressed by the developer sequentially conveyed onto the downstream side of the developer conveyance path, thereby applied with a shear force to the developer. A toner fluidity improver (additive) is buried in resin particles constituting the toners by the heat generation or the shear force due to the stress, and the developer fluidity is extremely degraded to hardly supply the sufficient amount of toner to the photoconductor drum through the development roller, which results in a problem in that density of an image printed on a recording medium is degraded.

On the other hand, Japanese Patent Application Laid-Open No. 2008-256917 proposes a cycling type development device in which lead angles of spiral blades of the first and second auger screws increase in a position where the spiral blades face the first and second communication paths in the developer tank so as to be parallel to the rotating shaft. According to the development device, the developer conveyed onto the downstream side of the developer conveyance path by the auger screw rotates circumferentially by a part having the large lead angle of the spiral blade, so that the developer can easily be oriented toward the communication path to reduce the stress applied to the developer.

The image forming apparatus includes a toner cartridge. The toner cartridge replenishes the toner into the development device such that toner density in the developer does not become a predetermined value or less by consumption of the toner in the development device during printing. For example, Japanese Patent Application Laid-Open No. 2006-235255 discloses a toner cartridge includes a toner storage portion in which the replenishment toner is stored, a toner discharge port that discharges the toner toward the development device, a toner conveyance path that is disposed between the toner storage portion and the toner discharge port, a paddle member that delivers the toner in the toner storage portion to the toner conveyance path, and an auger screw that conveys the toner in the toner conveyance path to the toner discharge port.

In the development device of Japanese Patent Application Laid-Open No. 2008-256917, because the spiral blade rotates, the part having the large lead angle of the spiral blade works so as to deliver the developer to the communication path, and the part also works so as to pull back the developer from the communication path. The developer conveyed to a lowermost downward part of the auger screw is not quickly conveyed from one of the developer conveyance paths to the other developer conveyance path, but the developer tends to be retained to continuously receive the stress. Therefore, the problem in that the density of the print image is degraded due to the degradation of the developer fluidity is not solved yet.

There is also the problem similar to that of the development device in the toner cartridge of Japanese Patent Application Laid-Open No. 2006-235255 that replenishes the unused toner to the development device and a conventional cleaning unit that removes the toner left on the photoconductor drum or a transfer belt after the toner image is transferred to a recording sheet. That is, for the conventional toner cartridge or cleaning unit, when the auger screw is rotated to convey the toner to a toner discharge port that is disposed on the downstream side of the toner conveyance path, the toner adheres to and deposits on a downstream wall surface of the toner conveyance path, and unfortunately the deposited toner receives a pressure from the sequentially-conveyed toner to be retained on the downstream wall surface. Additionally, the toner retained on the downstream wall surface of the toner conveyance path becomes a consolidation state to lead to a lock phenomenon that obstructs the rotation of the auger screw.

Accordingly, in view of the conventional problems, an object of the present invention is to provide a developer conveying device that can suppress the retention of the developer to smoothly convey the developer on the downstream side of the developer conveyance path through which the developer containing at least the toner is conveyed. Another object of the present invention is to provide a development device, a toner cartridge, and a cleaning unit, which are provided with the developer conveying device, and an image forming apparatus provided with the development device, the toner cartridge, and the cleaning unit.

### SUMMARY OF THE INVENTION

According to an aspect of the present invention, a developer conveying device (first invention) includes: a developer conveying cylinder that includes a developer conveyance path disposed therein while being extended in one direction, a toner introduction port disposed on an upstream side of the developer conveyance path to introduce a toner from an outside to the developer conveyance path, and a downstream opening opened in a direction orthogonal to the one direction on a downstream side of the developer conveyance path to circulate a developer containing at least the toner; and a screw-shaped shaft that is rotatably provided in the developer conveying cylinder to convey the toner in the developer conveyance path from the upstream side to the downstream side, wherein the screw-shaped shaft includes a rotating shaft that is journaled in an upstream wall portion and a downstream wall portion, which are included in the developer conveying cylinder, and a spiral blade that is mounted on an outer circumferential surface of the rotating shaft; the rotating shaft includes a conical portion that thickens gradually toward the downstream side in a position where the rotating shaft faces the downstream opening; and the spiral blade includes an agitating blade portion whose lead angle increases gradually toward the downstream side in a position where the spiral blade faces the downstream opening.

According to another aspect of the present invention, there is provided a development device (second invention) to be mounted on an electrophotographic image forming apparatus including a photoconductor drum in which an electrostatic latent image is formed on a surface thereof photoconductor, the development device includes: a developer tank that is integrally provided with the developer conveying device including the developer conveyance path that is of a first developer conveyance path and the screw-shaped shaft that is of a first screw-shaped shaft, and a two-component developer containing a toner and a carrier being stored in the developer tank; a second developer conveyance path that is disposed in the developer tank, the second developer conveyance path being parallel to the first developer conveyance path while being adjacent to the first developer conveyance path; a second screw-shaped shaft that is rotatably provided in the second developer conveyance path; and a development roller that is provided in the developer tank, the development roller rotating to supply the toner to a surface having the electrostatic latent image of the photoconductor drum while bearing the two-component developer, photoconductor wherein a downstream end of the first developer conveyance path is communicated with an upstream end of the second developer conveyance path through the downstream opening that is of a first communication path; an upstream end of the first developer conveyance path is communicated with a downstream end of the second developer conveyance path through a second communication path; the first and second screw-shaped shafts convey the developer in relatively reverse direction to cycle the developer in the developer tank; and first and second screw-shaped shafts supply the developer to the development roller.

According to still another aspect of the present invention, a toner cartridge (third invention) includes: a cartridge body that includes the developer conveying device and a toner storage portion that is disposed adjacent to the developer conveying device; a shutter that is provided at an outer surface side of the cartridge body to open and close the downstream opening that is of a toner discharge port of the developer conveying device; and a paddle member that is rotatably provided in the cartridge body to deliver the toner in the toner storage portion from the toner introduction port of the developer conveying device into the developer conveyance path.

According to still another aspect of the present invention, a cleaning unit (fourth invention) includes the developer conveying device and a blade member that is mounted at an opening edge of the toner introduction port in the developer conveying cylinder of the developer conveying device.

According to still another aspect of the present invention, an image forming apparatus (fifth invention) includes a photoconductor drum in which an electrostatic latent image is formed on a surface thereof; a charging device that charges the surface of the photoconductor drum; an exposure device that forms the electrostatic latent image on the surface of the photoconductor drum; the development device that supplies a toner to the electrostatic latent image on the surface of the photoconductor drum to form a toner image; a toner replenishment device that replenishes the toner to the development device; a transfer device that transfers the toner image on the surface of the photoconductor drum to a recording medium; and a fixing device that fixes the toner image to the recording medium.

According to still another aspect of the present invention, an image forming apparatus (sixth invention) includes a photoconductor drum in which an electrostatic latent image is formed on a surface thereof; a development device that supplies a toner to the electrostatic latent image on the surface of the photoconductor drum to form a toner image; the toner cartridge that replenishes the toner to the development device; a transfer device that transfers the toner image on the surface of the photoconductor drum to a recording medium; and a fixing device that fixes the toner image to the recording medium.

According to still another aspect of the present invention, an image forming apparatus (seventh invention) includes a photoconductor drum in which an electrostatic latent image is formed on a surface thereof; a development device that supplies a toner to the electrostatic latent image on the surface of the photoconductor drum to form a toner image; a transfer device that transfers the toner image on the surface of the photoconductor drum to a recording medium; a fixing device that fixes the toner image to the recording medium; a waste toner recovery portion; and the cleaning unit that is provided such that the blade portion abuts on the surface of the photoconductor drum, wherein the residual toner left on the surface of the photoconductor drum after the transfer is removed by the cleaning unit and conveyed to the waste toner recovery portion.

According to the developer conveying device of the present invention, because the spiral blade of the screw-shaped shaft includes the agitating blade portion whose lead angle increases gradually toward the downstream side at one end on the downstream side in the conveyance direction, an agitating force in a circumferential direction of the rotating shaft is enhanced while conveyance capability of the agitating blade portion in a developer conveyance direction decreases gradually. Because the rotating shaft of the screw-shaped shaft includes the conical portion that thickens gradually toward the downstream side at one end on the downstream side in the developer conveyance direction, the developer is moved in the radial direction of the rotating shaft by the conical portion.

The developer can quickly move from the developer conveyance path to the downstream opening by a synergistic effect. Therefore, the conditions that the developer is retained by striking on the downstream wall surface of the developer conveyance path and that the retained developer is pressed to receive the stress by the sequentially-conveyed developer can be suppressed. As a result, the problem, in which the toner fluidity improver (additive) is buried in the resin particles constituting the toners by the heat generation or the shear force due to the stress and therefore the developer fluidity is extremely degraded to degrade the toner fluidity, can be solved.

According to the development device including the developer conveying device and the image forming apparatus, the degradation of the developer fluidity can be suppressed to suppress the degradation of the print image density. According to the toner cartridge including the developer conveying device and the image forming apparatus, the lock phenomenon of the screw-shaped shaft is prevented, so that the toner can stably be supplied to the development device to form the image on the recording sheet at the stable image density. According to the cleaning unit including the developer conveying device and the image forming apparatus, the lock phenomenon of the screw-shaped shaft is prevented, so that an accident that the removed toner (waste toner) overflows onto the photoconductor drum side to contaminate the inside of the image forming apparatus with the toner because the cleaning unit is filled with the removed toner can be prevented to maintain a cleaning function of the cleaning unit.

### BRIEF DESCRIPTION OF THE DRAWINGS

FIG. 1 is a horizontal sectional view illustrating a developer conveying device according to a first embodiment of the present invention;

FIG. 2 is a sectional front view illustrating a modification of the developer conveying device of the first embodiment;

FIG. 3 is a partially enlarged front view illustrating part of a screw-shaped shaft in the developer conveying device of the first embodiment;

FIG. 4 is a partially enlarged plan view illustrating the part of the screw-shaped shaft in the developer conveying device of the first embodiment;

FIG. 5 is a sectional view taken on a line A-A of FIG. 4;

FIG. 6 is a partially enlarged front view illustrating part of a screw-shaped shaft in a developer conveying device according to a second embodiment of the present invention;

FIG. 7 is a partially enlarged front view illustrating a rotating shaft part of the screw-shaped shaft of the FIG. 6;

FIG. 8 illustrates an entire configuration of an image forming apparatus provided with a development device according to a third embodiment of the present invention including the developer conveying device of the first or second embodiment;

FIG. 9 is a schematic enlarged sectional view of the development device of FIG. 8;

FIG. 10 is a sectional view taken on a line B-B of FIG. 9;

FIG. 11 is a sectional view taken on a line C-C of FIG. 9;

FIG. 12 is a sectional view taken on a line D-D of FIG. 10;

FIG. 13 is a schematic sectional view illustrating a toner replenishment device in the development device of the first embodiment;

FIG. 14 is a sectional view taken on a line E-E of FIG. 13;

FIG. 15 is a perspective view illustrating a configuration of a toner cartridge unit that is provided with a toner cartridge according to a fourth embodiment of the present invention and mounted on the image forming apparatus of the third embodiment;

FIG. 16A is a sectional side view of the toner cartridge of the fourth embodiment;

FIG. 16B is a sectional view taken on a line F-F of the FIG. 16A;

FIG. 16C is a sectional view taken on a line G-G of the FIG. 16A;

FIG. 16D is a sectional view taken on a line H-H of the FIG. 16A,

FIG. 17 is a schematic sectional view illustrating a configuration of a cleaning unit according to a fifth embodiment of the present invention mounted on the image forming apparatus of the third embodiment when being viewed from an upstream side; and

FIG. 18 is a sectional view illustrating the cleaning unit of the fifth embodiment.

### DETAILED DESCRIPTION OF THE PREFERRED EMBODIMENTS

A developer conveying device according to an embodiment of the present invention includes a developer conveying cylinder and a screw-shaped shaft rotatably provided in the developer conveying cylinder, and the developer conveying device conveys a developer used to form an electrophotographic image system. For example, the developer conveying device is suitably applied to an electrophotographic image forming apparatus such as a monochrome or full-color copying machine, a printer, a facsimile, and a multifunction peripheral having functions thereof, particularly to a developer conveying mechanism of an image forming apparatus in which a two-component developer containing a toner and a carrier is used.

In the two-component developer, the toner develops an electrostatic latent image on a photoconductor drum of the image forming apparatus. As used herein, a “developer” includes not only the single toner used in the two-component developer but also the two-component developer in which the carrier is mixed with the toner. Accordingly, the developer conveying device of the embodiment is applied to a development device that conveys the two-component developer, a toner cartridge that conveys the single toner, and a conveying mechanism of a cleaning unit.

In a configuration of most of developer conveying mechanisms, a screw-shaped shaft is provided in a linear developer conveyance path, the screw-shaped shaft rotates to cause the developer to travel linearly, the developer makes a right-angle turn at a downstream end of a developer conveyance path, and the developer is conveyed to another conveyance path. At this point, usually the developer is easily retained in a corner part at the downstream end of the developer conveyance path. However, the developer conveying device of the embodiment has a function of suppressing the retention of the developer in the screw-shaped shaft.

The screw-shaped shaft includes a rotating shaft that is journaled in an upstream wall portion and a downstream wall portion of a developer conveying cylinder and a spiral blade that is mounted on an outer circumferential surface of the rotating shaft. A first feature of the screw-shaped shaft is that the rotating shaft includes a conical portion, which thickens gradually toward a downstream side, in a position where the rotating shaft faces a downstream opening of the developer conveying cylinder. A second feature is that the spiral blade includes an agitating blade portion, in which a lead angle of the spiral blade increases gradually toward the downstream side, in a position where the spiral blade faces the downstream opening of the developer conveying cylinder. As used herein, the “lead angle” means an angle of the spiral blade with respect to a plane that a shaft center of the rotating shaft perpendicularly pierces. Assuming that D is a diameter of the rotating shaft, L is a distance of one spiral pitch of the spiral blade, and α is the lead angle, an equation of L=πDtanα holds. That is, the lead angle becomes 0° when the spiral blade is parallel to the plane that the shaft center of the rotating shaft perpendicularly pierces.

The development device of the embodiment may be configured as the following (1) to (4), or these configurations may be combined.

(1) The lead angle of the agitating blade portion increases continuously. With this configuration, because a bent portion is not formed in the agitating blade portion unlike the case in which the lead angle of the agitating blade portion increases in a stepwise manner, a rapid pressure variation can be prevented from being applied to the developer conveyed in the agitating blade portion, and a stress applied to the developer can be suppressed.

(2) The lead angle of the agitating blade portion has a maximum value of 90°. With this configuration, because a part having the lead angle of 90° in the agitating blade portion is parallel to the rotating shaft, a torque in a circumferential direction of the rotating shaft can be maximized while the conveyance capability of the part having the lead angle of 90° in the developer conveyance direction becomes zero, and the retention of the developer can more effectively be suppressed.

(3) The conical portion includes a spiral groove in the outer circumferential surface thereof, and a spiral winding direction of the spiral groove is opposite to a spiral winding direction of the spiral blade. With this configuration, because the spiral groove biases the developer conveyed by the spiral blade in a direction in which the developer is pushed back when the rotating shaft rotates, the developer is prevented from being retained in the corner part at the downstream end of the developer conveyance path, and a pressure and the stress from the developer sequentially delivered to the corner part at the downstream end of the developer conveyance path can be reduced.

(4) The spiral blade is a double spiral blade. With this configuration, because the agitating blade portions are provided in opposite positions of 180° in the doubly-wound spiral blades, the developer can smoothly move from the developer conveyance path to a communication path.

As described above, the developer conveying device of the embodiment can be applied to the cycling type development device, toner cartridge, and cleaning unit. The development device may be configured as the following (A) and (B), or these configurations may be combined.

(A) The second developer conveyance path and the second screw-shaped shaft are included in the other developer conveying device, and downstream openings of the other developer conveying devices act as the second communication path. That is, the two developer conveying devices may be integrated so as to convey the developers in the opposite directions each other. Therefore, the developer can smoothly be conveyed from the first developer conveyance path to the first communication path, and the developer can smoothly be conveyed from the second developer conveyance path to the second communication path, so that the developer retention point can be eliminated in the developer tank.

(B) The developer tank includes a backflow prevention thread portion in a bottom portion of at least one of the first and second communication paths, and the first and second screw-shaped shafts rotate in a direction in which outer circumferential portions of the spiral blades of the first and second screw-shaped shafts come close to the backflow prevention thread portion from below. Therefore, the developer that is conveyed from one of the developer conveyance paths beyond the backflow prevention thread portion to the other developer conveyance path hardly returns, which allows the backflow of the developer to be prevented.

Hereinafter, a developer conveying device according to an embodiment of the present invention, and a development device, a toner cartridge and a cleaning unit, which are provided with the developer conveying device of the embodiment, and an image forming apparatus provided with the development device, the toner cartridge, and the cleaning unit will be described in detail with reference to the accompanying drawings.

### <Developer Conveying Device of First Embodiment>

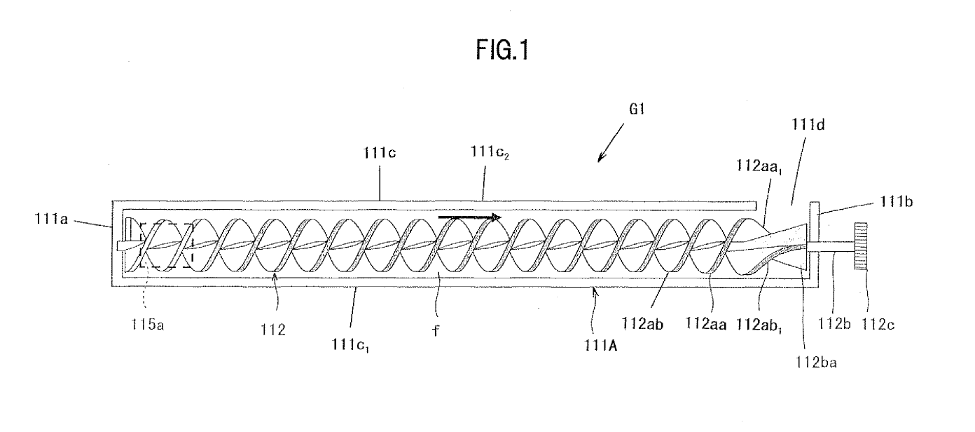

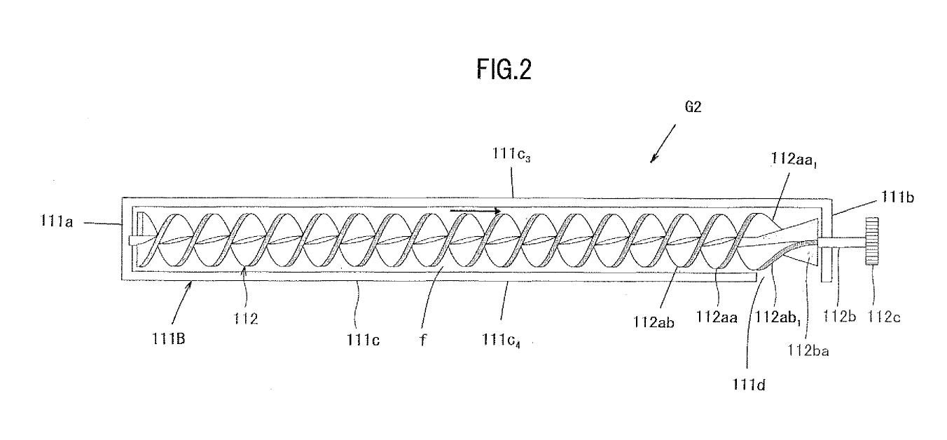

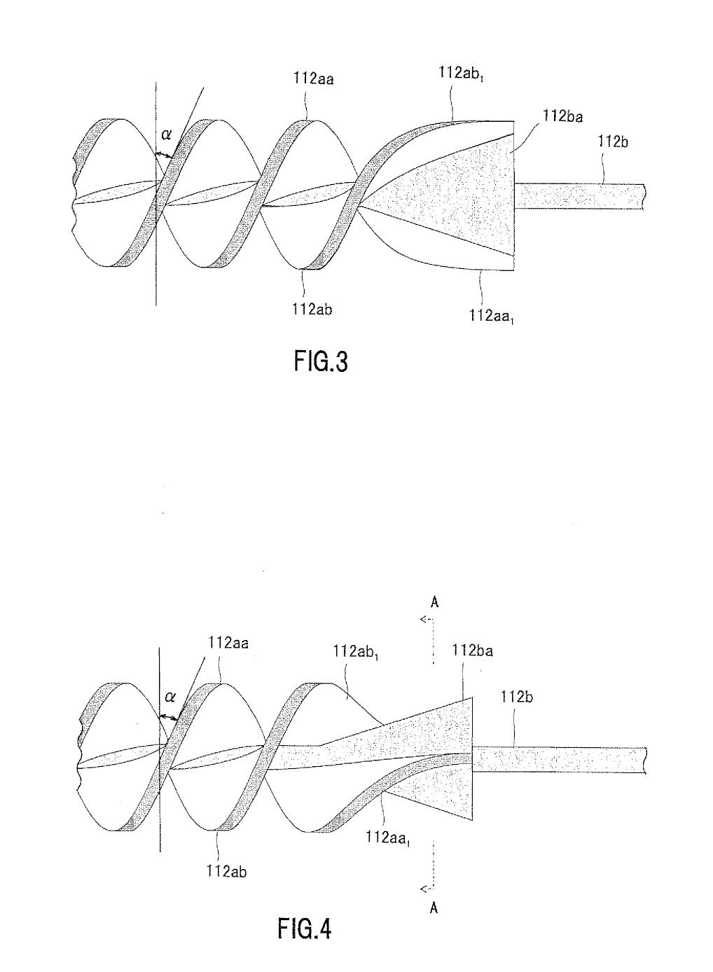

FIG. 1 is a horizontal sectional view illustrating a developer conveying device according to a first embodiment of the present invention, FIG. 2 is a sectional front view illustrating a modification of the developer conveying device of the first embodiment, FIG. 3 is a partially enlarged front view illustrating part of a screw-shaped shaft in the developer conveying device of the first embodiment, FIG. 4 is a partially enlarged plan view illustrating the part of the screw-shaped shaft in the developer conveying device of the first embodiment, and FIG. 5 is a sectional view taken on a line A-A of FIG. 4. In FIG. 2, the components similar to those of FIG. 1 are designated by the same numerals.

A developer conveying device G1 of FIG. 1 includes a developer conveying cylinder 111A and a screw-shaped shaft 112 that is rotatably provided in the developer conveying cylinder 111A. The developer conveying cylinder 111A includes an upstream wall portion 111a, a downstream wall portion 111b, and a surrounding wall portion 111c that includes a front wall 111c₁ and a rear wall 111c₂, which are located opposite each other, and an upper wall and a lower wall, which are located opposite each other. The developer conveying cylinder 111A is formed into a square tube shape extended in one direction, and an inside of the developer conveying cylinder 111A constitutes a developer conveyance path f. In the surrounding wall portion 111c, a toner introduction port 115a (dotted line part) is formed on an upstream side of the upper wall (not illustrated), and a downstream opening 111d is formed on a downstream side of the rear wall 111c₂. Alternatively, the downstream opening 111d may be formed on the downstream side of not the rear wall 111c₂ but the front wall 111c₁.

The positions where the toner introduction port 115a and the downstream opening 111d are formed is not limited to the above-described points. As illustrated in FIG. 2, in a developer conveying cylinder 111B of a developer conveying device G2 according to a modification of the first embodiment, the toner introduction port 115a is formed in the front wall (not illustrated) or the rear wall (not illustrated) of the surrounding wall portion 111c, and the downstream opening 111d may be formed on the downstream side of a lower wall 111c₄ of the surrounding wall portion 111c. Basically it is only necessary to open the downstream opening 111d in a direction orthogonal to a longitudinal direction of the developer conveyance path f.

The screw-shaped shaft 112 is shared by the developer conveying device G1 of FIG. 1 and the developer conveying device G2 of FIG. 2. The screw-shaped shaft 112 includes a rotating shaft 112b that is journaled in the upstream wall portion 111a and the downstream wall portion 111b of the developer conveying cylinder 111A or the developer conveying cylinder 111B, double spiral blades 112aa and 112ab that are mounted on an outer circumferential surface of the rotating shaft 112b, and a gear 112c that is mounted at a downstream end of the rotating shaft 112b piercing the downstream wall portion 111b. The gear 112c engages a driving gear of an image forming apparatus including the developer conveying device G1 or the developer conveying device G2, and the gear 112c transmits a torque from the driving gear to the rotating shaft 112b.

As illustrated in FIGS. 1 to 5, the rotating shaft 112b includes a conical portion 112bain a position where the rotating shaft 112b faces the downstream opening 111d, and the conical portion 112ba thickens gradually toward the downstream side. In the first embodiment, the rotating shaft 112b has a cylindrical shape, the conical portion 112ba has a circular truncated cone shape, and a diameter of the conical portion 112ba increases from the rotating shaft 112b to substantially maximum diameters of the spiral blades 112aa and 112ab.

The spiral blades 112aa and 112ab include agitating blade portions 112aa₁ and 112ab₂ in positions where the spiral blades 112aa and 112ab face the downstream opening 111d, respectively. The lead angles a of the agitating blade portions 112aa₁ and 112ab₂ increase gradually toward the downstream side. In the first embodiment, the lead angle α is kept constant in parts except the agitating blade portions 112aa₁ and 112ab₁ of the spiral blades 112aa and 112ab. For example, the lead angle α is set to an arbitrary angle from a range of 20 to 50°. The lead angles α of the agitating blade portions 112aa₁ and 112ab₁ become the maximum on the lowermost downstream end side. The maximum lead angle α becomes 90°, and the agitating blade portions 112aa₁ and 112ab₁ at the lead angle α of 90° become parallel to the rotating shaft 112b.

In the configurations of the developer conveying devices G1 and G2 of FIGS. 1 and 2, the spiral blades 112aa and 112ab of the screw-shaped shaft 112 rotate to convey the developer (not illustrated) in the developer conveyance path f from the upstream side toward the downstream side. At this point, a conveyance force is mainly applied to the developer in a conveyance direction (arrow direction). Because the lead angle a increases toward the downstream side in the agitating blade portions 112aa₁ and 112ab₁ of the spiral blades 112aa and 112ab, the developer conveyance capability decreases gradually in a developer conveyance direction, and an agitating force increases in a circumferential direction of the rotating shaft. The developer is moved in a radial direction of the rotating shaft by the conical portion 112ba that thickens gradually toward the downstream side of the rotating shaft 112c.

Because the developer can quickly move from the developer conveyance path f to the downstream opening 111d, the developer retention caused by abutment on the downstream side-surface 111b of the developer conveyance path f is reduced, and therefore the stress applied to the retained developer by the pressing force of the sequentially-conveyed developer is reduced. At this point, the stress applied to the developer is similarly reduced, even if the downstream side opening 111d is opened in a horizontally orthogonal direction with respect to the conveyance direction (see FIG. 1), or even if the downstream side opening 111d is opened in a downwardly orthogonal direction with respect to the conveyance direction (see FIG. 2). As a result, the conventional problem, in which the toner fluidity improver (additive) is buried in resin particles constituting the toners by the heat generation or the shear force due to the stress and therefore the developer fluidity is extremely degraded to degrade the toner fluidity, is solved.

### <Developer Conveying Device of Second Embodiment>

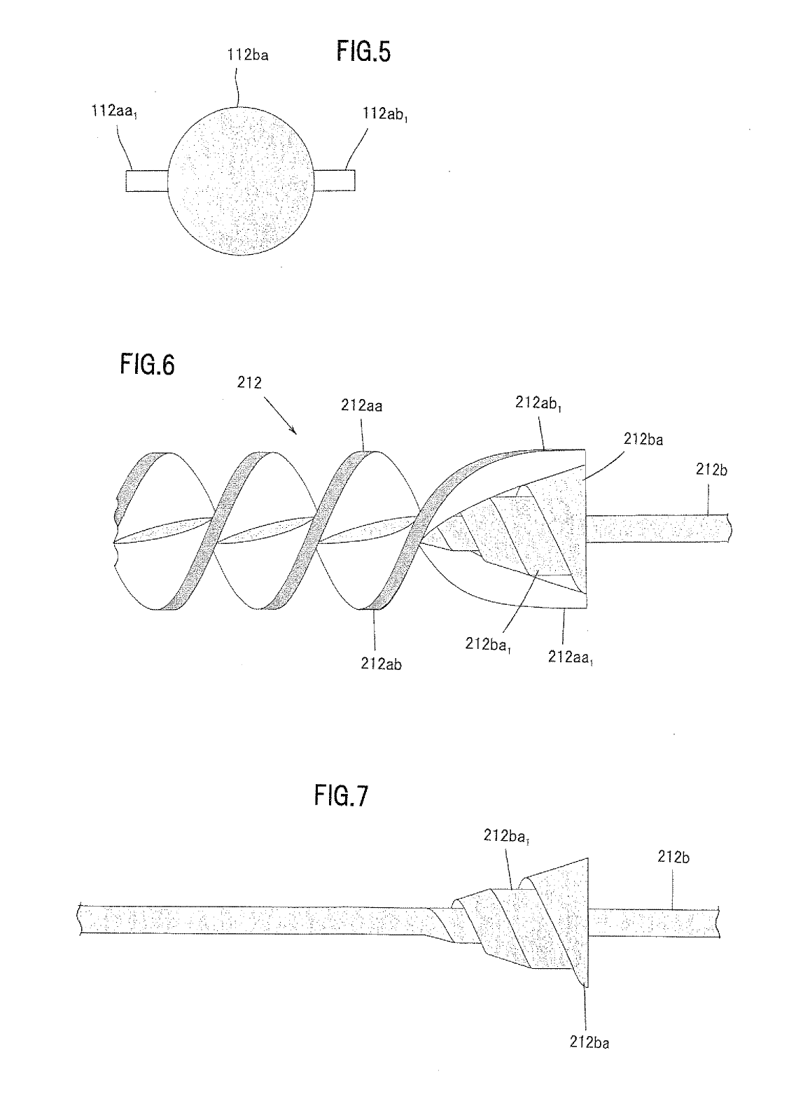

FIG. 6 is a partially enlarged front view illustrating part of a screw-shaped shaft in a developer conveying device according to a second embodiment of the present invention, and FIG. 7 is a partially enlarged front view illustrating a rotating shaft part of the screw-shaped shaft of the FIG. 6. The developer conveying device of the second embodiment has a configuration similar to that of the first embodiment except that a rotating shaft 212b of a screw-shaped shaft 212 differs from the rotating shaft 112b of the screw-shaped shaft 112 of the first embodiment. The different point of the second embodiment will mainly be described below.

As illustrated in FIGS. 6 and 7, similarly to the first embodiment, the rotating shaft 212b of the screw-shaped shaft 212 includes a conical portion 212ba, and the conical portion 212ba includes a spiral groove 212ba₁ in an outer circumferential surface thereof. That is, the conical portion 212ba of the second embodiment corresponds to one in which the spiral groove 212ba₁ is formed in an opposite direction to the spiral winding directions of the spiral blades 112aa and 112ab in the outer circumferential surface of the circular truncated cone shaped conical portion 112ba of the first embodiment. In the second embodiment, agitating blade portions 212aa₁ and 212ab₁ of spiral blades 212aa and 212ab are joined to a tapered surface of the conical portion 212ba, and gaps are formed between the agitating blade portions 212aa₁ and 212ab₁ and the spiral groove 212ba₁ According to the developer conveying device of the second embodiment, the effect similar to that of the first embodiment is obtained. Additionally, because the spiral groove 212ba₁ biases the developer conveyed by the spiral blades 212aa and 212ab in the direction the developer is pushed back when the rotating shaft 212b rotates, the developer is prevented from being retained in the corner part at the downstream end of the developer conveyance path, and the pressure and the stress from the sequentially-delivered developer can be further reduced.

### <Development Device of Third Embodiment>

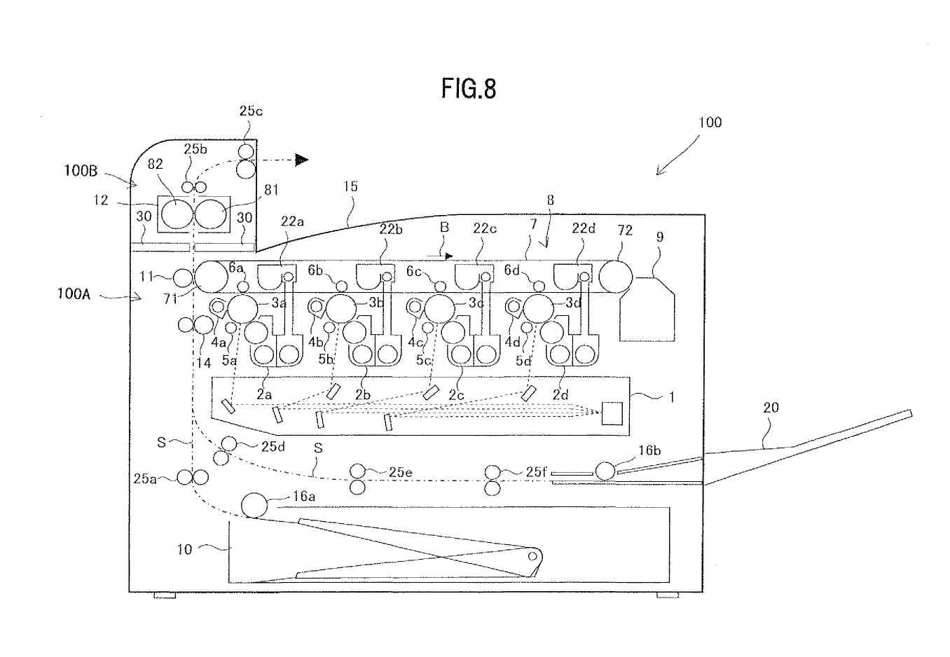

FIG. 8 illustrates an entire configuration of an image forming apparatus provided with a development device according to a third embodiment of the present invention including the developer conveying device of the present invention. An image forming apparatus 100 includes a development device accommodation portion 100A in which plural development devices 2a to 2d are accommodated in a casing thereof, fixing device accommodation portion 100B in which a fixing device 12 is accommodated in a casing thereof, and a division wall 30 that is provided between the development device accommodation portion 100A and the fixing device accommodation portion 100B to insulate heat of the fixing device 12 such that the heat is not transferred onto a development device side. The fixing device accommodation portion 100B is located above the development device accommodation portion 100A. The image forming apparatus 100 is a printer that can form a multi-color or monochrome image on a sheet-like recording medium (recording sheet) according to externally transmitted image data. An upper surface of the development device accommodation portion 100A, located beside the fixing device accommodation portion 100B, constitutes a sheet discharge tray 15.

In the third embodiment, the image forming apparatus is the printer by way of example. Alternatively, the image forming apparatus may be a copying machine, a facsimile, or a multifunction peripheral, which can form the multi-color or monochrome image on the recording medium according to the externally-transmitted image data and/or image data scanned from an original by a scanner.

### [Development Device Accommodation Portion]

As illustrated in FIG. 8, the development device accommodation portion 100A includes: four photoconductive drums 3a, 3b, 3c, and 3d; four chargers (charging device) 5a, 5b, 5c, and 5d that charge surfaces of the photoconductive drums 3a to 3d; an exposure unit (exposure device) 1 that forms electrostatic latent images on the surfaces of the photoconductive drums 3a to 3d; four development devices 2a, 2b, 2c, and 2d in which black, cyan, magenta, and yellow toners are individually stored, the development devices 2a to 2d developing the electrostatic latent images on the surfaces of the photoconductive drums 3a to 3d to form toner images; cleaner units 4a, 4b, 4c, and 4d that remove residual toners left on the surfaces of the photoconductive drums 3a to 3d after the development and image transfer; four toner replenishment devices 22a, 22b, 22c, and 22d that individually replenish the four color toners to the development device 2a to 2d; an intermediate transfer belt unit (transfer device) 8 that transfers the toner image on the surface of the photoconductive drums 3a to 3d to the recording medium; and an intermediate transfer belt cleaning unit 9.

The development device accommodation portion 100A also includes: a paper feeding tray 10 that is disposed in a lowermost part of the development device accommodation portion 100A, the plural recording mediums being stored in the paper feeding tray 10; a manual paper feeding tray 20 that is disposed on one side surface of the development device accommodation portion 100A, an irregular-size recording medium being set on the manual paper feeding tray 20; and a sheet conveyance path S through which the recording medium is conveyed to the intermediate transfer belt unit (transfer device) 8 from the paper feeding tray 10 or the manual paper feeding tray 20. In the members designated by the numerals “a” to “d”, the numeral “a” designates the member used to form the black image, the numeral “b” designates the member used to form the cyan image, the numeral “c” designates the member used to form the magenta image, and the numeral “d” designates the member used to form the yellow image.

In the image forming apparatus 100, the black toner image, the cyan toner image, the magenta toner image, and the yellow toner image are selectively formed on the surfaces of the photoconductive drums 3a to 3d based on the image data of the black, cyan, magenta, and yellow color components, and the formed toner images are superposed on the intermediate transfer belt unit 8 to form a color image on the recording medium. Because the photoconductive drums 3a to 3d corresponding to the colors have the same configuration, the numerals 3a to 3d are unified by the numeral 3 in the description of the configurations of the photoconductive drums 3a to 3d. Similarly, the numerals 2a to 2d are unified by the numeral 2 in the development device, the numerals 5a to 5d are unified by the numeral 5 in the charger, the numerals 4a to 4d are unified by the numeral 4 in the cleaner unit, and the numerals 22a to 22d are unified by the numeral 22 in the toner replenishment device.

### (Photoconductive Drum and Peripheral Members Thereof)

The photoconductive drum 3 includes a conductive base body and a photoconductive layer that is formed on a surface thereof, and the photoconductive drum 3 is a cylindrical member that forms the latent image by the charging and the exposure. The photoconductive drum 3 exhibits a conductive property by light irradiation, and an electric image called the electrostatic latent image is formed on the surface thereof. The photoconductive drum 3 is supported by a driving section (not illustrated) so as to be able to rotate about a shaft line.

For example, a contact roller type charger, a contact brush type charger, or a non-contact type charger is used as the charger 5 to evenly charge the surface of the photoconductive drum 3 at a predetermined potential.

The exposure unit 1 causes light corresponding to the image data to pass between the charger 5 and the development device 2, and irradiates the surface of the charged photoconductive drum 3 with the light to perform the exposure, thereby forming the electrostatic latent image corresponding to the image data on the surface of the photoconductive drum 3. In the first embodiment, a Laser Scanning Unit (LSU) including a laser irradiation portion and a reflecting mirror is used as the exposure unit 1 by way of example. Alternatively, an EL (Electroluminescence) or LED write head in which light emitting element are arrayed may be used as the exposure unit 1.

### (Development Device)

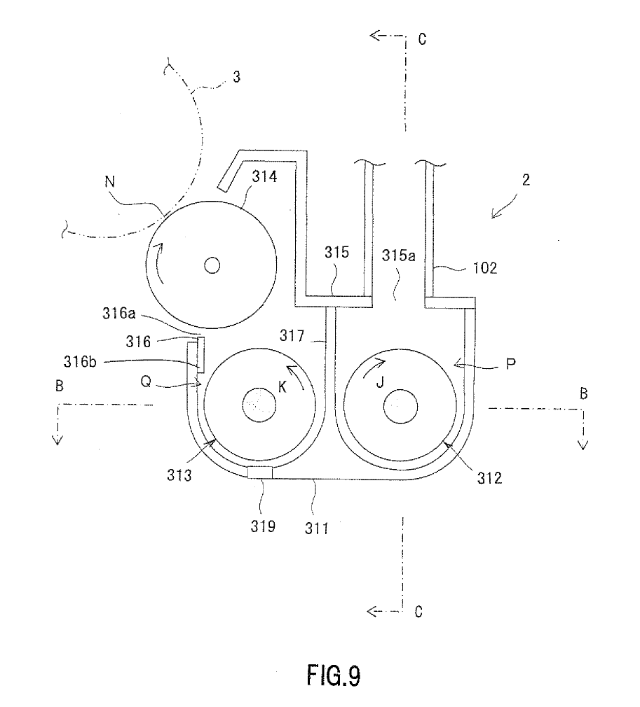

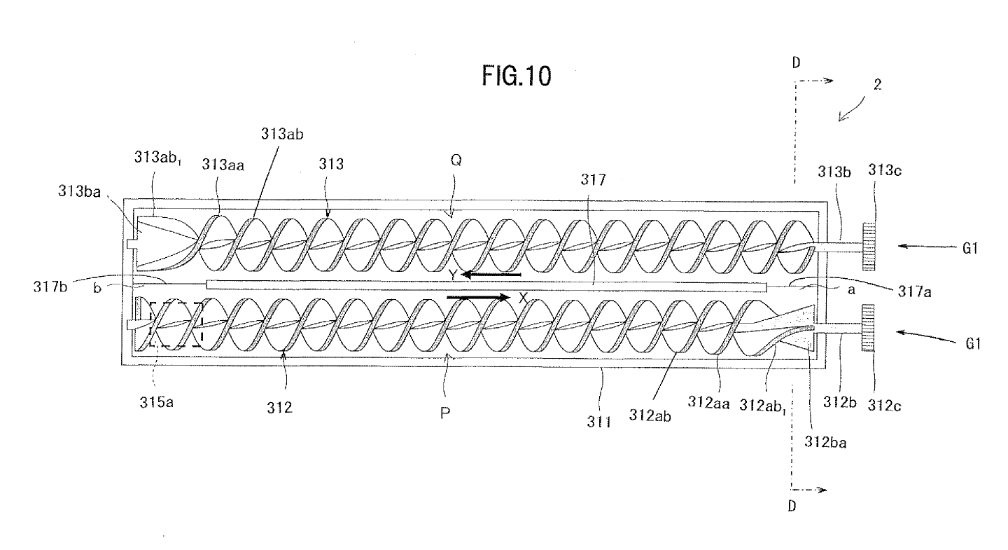

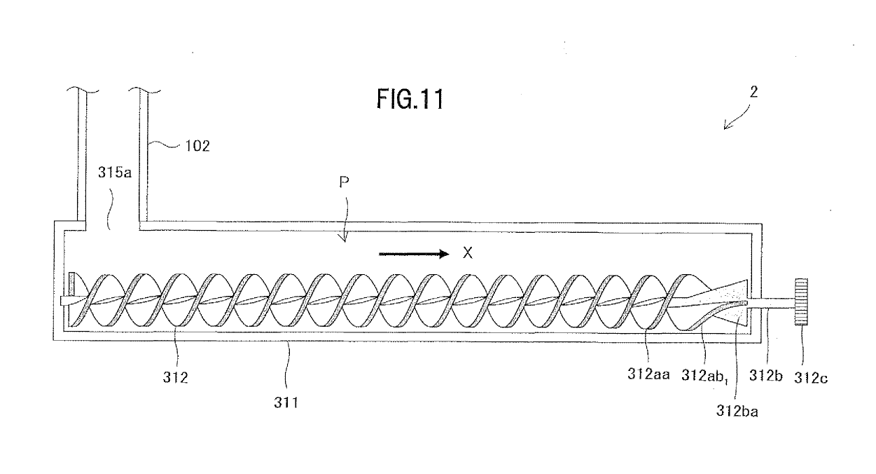

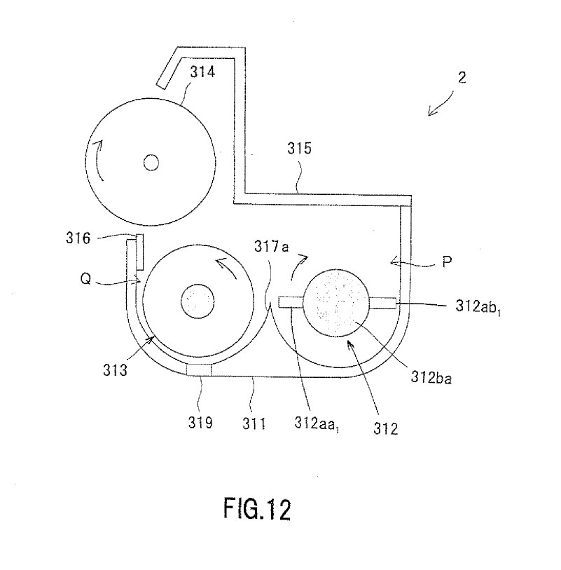

FIG. 9 is a schematic enlarged sectional view of the development device of FIG. 8, FIG. 10 is a sectional view taken on a line B-B of FIG. 9, FIG. 11 is a sectional view taken on a line C-C of FIG. 9, and FIG. 12 is a sectional view taken on a line D-D of FIG. 10. In FIGS. 9 to 12, the developer stored in a developer tank 311 is not illustrated.

As illustrated in FIGS. 9 to 12, the development device 2 includes a substantially rectangular developer tank 311 in which the two-component developer containing the toner and the carrier is stored, a toner replenishment port 315a through which the toners are replenished into the developer tank 311, a development roller 314 that is provided in the developer tank 311, first and second developer conveyance paths P and Q that are provided between the development roller 314 and a position in which the toners are replenished into the developer tank 311, first and second communication paths a and b that are provided on both end sides of the first and second developer conveyance paths P and Q to communicate the first and second developer conveyance paths P and Q, first and second screw-shaped shafts 312 and 313 that are rotatably provided in the first and second developer conveyance paths P and Q, a doctor blade 316, and a toner density detection sensor (magnetic permeability sensor) 319. In the development device 2, the toner is supplied to the surface of the photoconductor drum 3 by the development roller 314, and the electrostatic latent image formed on the surface of the photoconductor drum 3 is visualized (developed). In the development device 2, the developer conveying device G1 of the first embodiment is incorporated in the developer tank 311 and the first and second screw-shaped shafts 312 and 313.

The developer tank 311 is partitioned into two chambers by a partition plate 317 that is parallel to a shaft center direction of the development roller 314. In the two chambers, the chamber located on the side of the toner replenishment port 315a is the first developer conveyance path P, and the chamber located on the side of the development roller 314 is the second developer conveyance path Q. The first developer conveyance path P and the second developer conveyance path Q are communicated with each other by the first communication path “a” and the second communication path “b”, which are located on both the sides in the shaft center direction. Therefore, the first and second developer conveyance paths P and Q and the first and second communication paths a and b constitute one cyclic developer conveyance path.

The developer tank 311 has a detachable developer tank cover 315 that constitutes an upper wall thereof. In the developer tank cover 315, the toner replenishment port 315a is formed in order to replenish the unused toner on an upstream side in a developer conveyance direction (direction of arrow X) of the first developer conveyance path P. The developer tank 311 has an opening located between a sidewall on the side of the second developer conveyance path Q and a lower end edge of the developer tank cover 315. The development roller 314 is rotatably disposed in the position of the opening while a predetermined development nip portion N is provided between the development roller 314 and the photoconductive drum 3.

The development roller 314 is a magnet roller that rotates about the shaft center by a driving section (not illustrated). The development roller 314 supports the developer of the developer tank 311 on the surface thereof to supply the toner to the photoconductive drum 3. A development bias voltage is applied to the development roller 314 from a power supply (not illustrated) to supply the toner to the electrostatic latent image on the surface of the photoconductive drum 3 from the developer on the surface of the development roller 314.

The doctor blade 316 is a rectangular plate-like member that is extended in parallel with the shaft line direction of the development roller 314. A lower end 316b of the doctor blade 316 is fixed to the lower end edge of the opening of the developer tank 311, and an upper end 116a is separated from the surface of the development roller 314 with a predetermined gap. Examples of a material for the doctor blade 116 include stainless steel, aluminum, and synthetic resin.

The first and second screw-shaped shafts 312 and 313 are identical to the screw-shaped shaft 112 of the first embodiment (FIGS. 1 to 5). That is, the configuration in which the first and second screw-shaped shafts 312 and 313 are provided in the developer tank 311 corresponds to one in which the two developer conveying devices G1 of FIG. 1 are combined. In FIGS. 10 to 12, the numerals 312aa and 313aa designate spiral blades, the numerals 312ab₁ and 313ab₁ designate agitating blade portions, the numerals 312b and 313b designate rotating shafts, the numerals 312ba and 313ba designate conical portions, and the numerals 312c and 313c designate gears.

More particularly, the developer conveyance path “f” and the screw-shaped shaft 112 of one of the developer conveying devices G1 correspond to the first developer conveyance path P and the first screw-shaped shaft 312, the developer conveyance path “f” and the screw-shaped shaft 112 of the other developer conveying device G1 correspond to the second developer conveyance path Q and the second screw-shaped shaft 313, the toner introduction port 115a of one of the developer conveying devices G1 corresponds to the upstream toner introduction port 315a of the first developer conveyance path P, and the downstream openings of the developer conveying device G1 and G1 correspond to the first and second communication paths “a” and “b”. Additionally, in this case, as illustrated in FIGS. 10 and 12, the developer tank 311 includes backflow prevention thread portions 317a and 317b in bottom portions of the first and second communication paths “a” and

The gear 312c of the first screw-shaped shaft 312 engages a first driving gear of a driving section (not illustrated, for example, motor), the gear 313c of the second screw-shaped shaft 313 engages a second driving gear of the driving section, and the first driving gear and the second driving gear relatively reversely rotate, whereby the gears 312c and 313c relatively reversely rotate. Because the spiral blades 312aa and 312ab of the first screw-shaped shaft 312 and the spiral blades 313aa and 313ab of the second screw-shaped shaft 313 relatively reversely rotate, as illustrated in FIG. 10, the developer in the first developer conveyance path P is conveyed in the direction of the arrow X while being agitated in the rotation direction, and the developer in the second developer conveyance path Q is conveyed in the direction of the arrow Y while being agitated in the rotation direction. At this point, the first and second screw-shaped shafts 312 and 313 relatively reversely rotate in directions (directions of arrows J and K) in which the outer circumferential portions of the spiral blades thereof come close to the backflow prevention thread portions 317a and 317b from below.

Alternatively, the development device 2 may be formed such that the gears 312c and 313c engage each other, one of the gears 312c and 313c engages one driving gear to rotate, and the first screw-shaped shaft 312 and the second screw-shaped shaft 313 relatively reversely rotate. Therefore, the developer is conveyed in the opposite directions in the first developer conveyance path P and the second developer conveyance path Q. Alternatively, the development device 2 may be formed such that the spiral winding orientation of the spiral blades 312aa and 312ab of the first screw-shaped shaft 312 and the spiral winding orientation of the spiral blades 313aa and 313ab of the second screw-shaped shaft 313 are relatively provided in the opposite directions, and the gears 312c and 313c engage the same driving gear to rotate in the same direction, whereby the developer is conveyed in the opposite directions in the first developer conveyance path P and the second developer conveyance path Q.

In the first developer conveyance path P during the conveyance of the developer, the conveyance force in the conveyance direction (direction of arrow X) decreases gradually with respect to the developer conveyed to the position at which the first developer conveyance path P faces the first communication path a, and the agitation force in the rotation direction increases gradually by the agitating blade portions 312aa₁ and 312ab₁ of the first screw-shaped shaft 312. Additionally, the developer is also moved in the radial direction of the rotating shaft by the conical portion 312ba. Accordingly, the developer moves smoothly without flowing back from the first developer conveyance path P to the first communication path a, and the developer is hardly retained in the corner part of the first developer conveyance path P. Similarly, in the second developer conveyance path P, the developer conveyed in the conveyance direction (direction of arrow Y) moves smoothly without flowing back from the second developer conveyance path Q to the second communication path b, and the developer is hardly retained in the corner part of the second developer conveyance path Q. As a result, because the developer that is retained in the corner parts of the first and second developer conveyance paths P and Q to continuously receive the stress is reduced, the developer fluidity degradation is suppressed to suppress the print image density degradation caused by the insufficient amount of developer supplied to the development roller 314.

A toner density detection sensor 319 is mounted on a bottom surface of the developer tank 311 immediately below the second screw-shaped shaft 313 and a substantially central part of the second developer conveyance path Q, and a sensor surface of the toner density detection sensor 319 is exposed to the inside of the second developer conveyance path Q. The toner density detection sensor 319 is electrically connected to a toner density control section (not illustrated).

According to a toner density measured value detected by the toner density detection sensor 319, the toner density control section rotates a toner discharging member 122 of the toner replenishment device 22 to be described later (see FIG. 11) and discharges the toner through a toner discharge port 123 to supply the toner into the first developer conveyance path P of the development device 2.

When the toner density control section determines that the toner density measured value is lower than the toner density setting value, the toner density control section transmits a control signal to a driving section that rotates and drives the toner discharging member 122, and the driving section rotates the toner discharging member 122. For example, general toner density detection sensor such as a transmitted light detection sensor, a reflected light detection sensor, and a permeability detection sensor can be used as the toner density detection sensor 319. Among these, preferably the permeability detection sensor is used as the toner density detection sensor 319.

A power supply (not illustrated) is connected to the permeability detection sensor (toner density detection sensor 319). The power supply applies a driving voltage to the permeability detection sensor to drive the permeability detection sensor, and the power supply also applies a control voltage to the permeability detection sensor to output a detection result of the toner density to the control section. The voltage applied to the permeability detection sensor from the power supply is controlled by the control section. When the control voltage is applied to the permeability detection sensor, the permeability detection sensor outputs the detection result of the toner density as an output voltage value. Because basically the permeability detection sensor has good sensitivity near a median value of the output voltage, the control voltage is applied to the permeability detection sensor such that the output voltage near the median value is obtained. This kind of permeability detection sensor is commercially available. For example, product names TS-L, TS-A, and TS-K (TDK Corporation) can be cited as the permeability detection sensor.

### (Toner Replenishment Device)

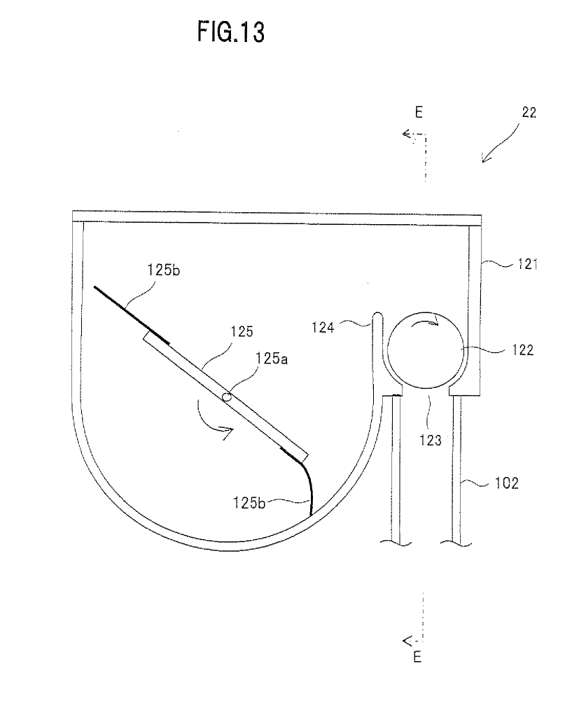

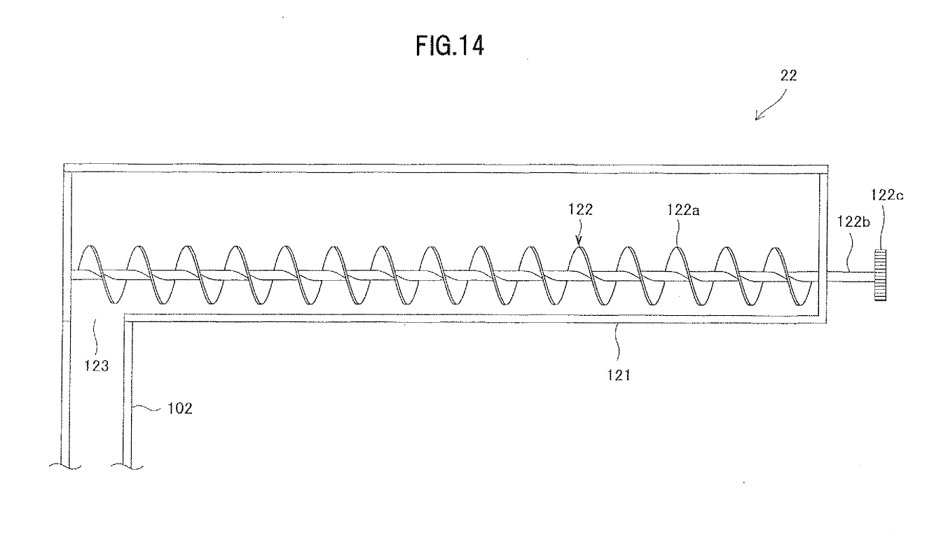

FIG. 13 is a schematic sectional view illustrating the toner replenishment device in the development device of the first embodiment, and FIG. 14 is a sectional view taken on a line E-E of FIG. 13. As illustrated in FIGS. 13 and 14, the toner replenishment device 22 includes a toner storage container 121 having the toner discharge port 123, a toner agitating member 125, and a toner discharging member 122. The unused toner is stored in the toner replenishment device 22. The toner replenishment device 22 is disposed above the developer tank 111 (see FIG. 1), and the toner discharge port 123 and the toner replenishment port 315a (see FIG. 9) of the development device 2 are connected by a toner conveyance pipe 102.

The toner storage container 121 is a substantially semi-cylindrical container member having an internal space, and the toner discharge port 123 is disposed at a lateral position in a circumferential direction of the semi-cylindrical part. The toner agitating member 125 is rotatably disposed at the substantially central position in the semi-cylindrical part of the toner storage container 121, and the toner discharging member 122 is rotatably disposed above and near the toner discharge port 123.

The toner agitating member 125 is a plate-like member that rotates about a rotating shaft 125a, and the toner agitating member 125 includes sheet-like toner scooping-up members 125b made of flexible resin (for example, polyethylene terephthalate) at both leading ends separated from the rotating shaft 125a. The rotating shaft 125a is rotatably supported on sidewalls on both sides in the longitudinal direction of the toner storage container 121, and one end of the rotating shaft 125a pierces the sidewall and is connected to a gear that engages a driving gear of a driving section (not illustrated).

The toner scooping-up member 125b rotates from below to upward with respect to the toner discharge port 123, whereby the toner agitating member 125 scoops up the toner stored in the toner storage container 121 to convey the toner to the toner discharging member 122 while agitating the toner. At this point, because of flexibility, the toner scooping-up member 125b rotates while being deformed by sliding along the inside wall of the toner storage container 121, and the toner scooping-up member 125b supplies the toner onto the side of the toner discharging member 122. A toner discharging member division wall 124 is provided between the toner discharging member 122 and the toner agitating member 125 such that the toner scooped up by the toner agitating member 125 can be retained a proper amount of toner around the toner discharging member 122.

The toner discharging member 122 includes a rotating shaft 122b whose both ends are rotatably supported on sidewalls on both sides in the longitudinal direction of the toner storage container 121, a spiral blade 122a that is fixed to an outer circumferential surface of the rotating shaft 122b, and a gear 122c that is fixed to one end of the rotating shaft 122b. The end of the rotating shaft 122b pierces the sidewall of the toner storage container 121. The gear 122c engages a driving gear of a driving section (not illustrated). The toner discharge port 123 is disposed on the downstream side in the direction in which the toner is conveyed by the toner discharging member 122. The toner is conveyed toward the side of the toner discharge port 123 by the spiral blade 122 by the rotation of the toner discharging member 122, and the toner is supplied from the toner discharge port 123 into the developer tank 111 through the toner conveyance pipe 102.

### <<Actuation of Development Device≦≦

Actuation of the development device 2 will be described below with reference to FIGS. 9 to 14. As illustrated in FIGS. 9 and 10, in a development process of the image forming apparatus, the development roller 314 and the first and second screw-shaped shafts 312 and 313 of the development device 2 rotate in the directions of the arrows J and K, respectively. At this point, the developer in the first developer conveyance path P is conveyed in the direction of the arrow X (FIGS. 10 and 11) by the first screw-shaped shaft 312 while being agitated in the circumferential direction of the rotation, and the toner is delivered onto the downstream side. The developer in the second developer conveyance path Q is conveyed in the direction of the arrow Y (see FIG. 10) by the second screw-shaped shaft 313 while being agitated in the circumferential direction of the rotation, and the toner is delivered onto the downstream side. At the same time, the downstream developer in the first developer conveyance path P is taken up by the agitating blade portions 312aa₁ and 312ab₁ and smoothly delivered to the second developer conveyance path Q through the first communication path a, and the downstream developer in the second developer conveyance path Q is taken up by the agitating blade portions 313aa₁ and 313ab₁ and smoothly delivered to the first developer conveyance path P through the second communication path b. Thus, the developer in the developer tank 311 is cycled between the first developer conveyance path P and the second developer conveyance path Q, and the toner of the developer is sufficiently charged by the friction between the toner and the carrier.

Part of the developer moved in the second developer conveyance path Q is supplied to the development roller 314. The developer supplied to the development roller 314 is delivered to the photoconductive drum 3 (see FIG. 9) while becoming a developer layer having an even thickness in the outer circumferential surface of the development roller 314 by the doctor blade 316, and the toner is partially supplied from the developer layer to the photoconductive drum 3. Then the developer whose toner density is degraded is mixed with the developer in the second developer conveyance path Q from the development roller 314. Accordingly, the toner density is gradually degraded in the developer of the second developer conveyance path Q.

Because the toner density of the developer in the second developer conveyance path Q is detected by the toner density sensor 319, when the toner density becomes a predetermined value or less, the toner replenishment device 22 replenishes the unused toner onto the developer (internal developer) in the first developer conveyance path P, and the replenishment toner is mixed and dispersed in the internal developer by the rotation of the first screw-shaped shaft 112.

### (Intermediate Transfer Belt Unit and Intermediate Transfer Belt Cleaning Unit)

As illustrated in FIG. 8, the intermediate transfer belt unit 8 disposed above the photoconductive drum 3 includes an intermediate transfer belt 7, intermediate transfer roller 6a, 6b, 6c, and 6d (hereinafter, the numerals are unified by the numeral 6) that tension the intermediate transfer belt 7 thereabout to rotate the intermediate transfer belt 7 in the direction of arrow B of FIG. 8, a driving roller 71, a driven roller 72 and a belt tension mechanism (not illustrated), and a transfer roller 11 that is disposed beside the driving roller 71 while brought close to the driving roller 71. The intermediate transfer rollers 6 are supported on roller mounting portions in the belt tension mechanism. Additionally, an intermediate transfer belt cleaning unit 9 is disposed on the side of the driven roller 72 of the intermediate transfer belt unit 8.

The driving roller 71 and the driven roller 72 are disposed outside the photoconductive drums 3 located on both ends of the four photoconductive drums 3 such that the intermediate transfer belt 7 comes into contact with the photoconductive drums 3. The intermediate transfer belt 7 is formed in an endless manner using a film having a thickness of about 100 to about 150 μm. The toner images of the color components formed on the photoconductive drum 3 are sequentially transferred to and superposed on the outside surface of the intermediate transfer belt 7, thereby forming the color toner image (multi-color toner image).

The toner image is transferred from the photoconductive drum 3 to the intermediate transfer belt 7 by the intermediate transfer rollers 6 that are in contact with an inside surface of the intermediate transfer belt 7. The intermediate transfer roller 6 includes a metallic shaft (for example, stainless steel) having a diameter of 8 to 10 mm and a conductive elastic material layer. The outer circumferential surface of the metallic shaft is covered with the conductive elastic material layer. Examples of the material for the conductive elastic material layer include ethylene-propylene-diene ternary copolymer (EPDM) including a conductive agent such as carbon black and urethane foam. A high-voltage transfer bias (high voltage of a polarity (+) opposite toner charging polarity (−)) is applied to the metallic shaft of the intermediate transfer roller 6 in order to transfer the toner image, which allows the intermediate transfer roller 6 to evenly apply the high voltage to the intermediate transfer belt 7. In the first embodiment, the intermediate transfer roller 6 is used as the transfer electrode. In addition, for example, a brush may be used.

The toner images laminated on the outside surface of the intermediate transfer belt 7 is moved to the position (transfer portion) of the transfer roller 11 by the rotation of the intermediate transfer belt 7. On the other hand, the recording medium is also conveyed to the transfer portion through the sheet conveyance path S, and the transfer roller 11 presses the recording medium against the intermediate transfer belt 7, thereby transferring the toner images on the intermediate transfer belt 7 to the recording medium. At this point, the intermediate transfer belt 7 and the transfer roller 11 are pressed against each other at a predetermined nip, and the high voltage for transferring the toner image onto the recording medium having a polarity (+) opposite the toner charging polarity (−) is applied to the transfer roller 11. One of the transfer roller 11 and the driving roller 71 is made of a hard material such as metal while the other is made of a soft material such as rubber and a foaming resin such that the nip between the intermediate transfer belt 7 and the transfer roller 11 is steadily obtained.

The toner that is not transferred from the intermediate transfer belt 7 to the recording medium but left on the intermediate transfer belt 7 causes color mixture of the toner when the new toner image is laminated on the intermediate transfer belt 7. Therefore, the residual toner is removed and recovered by the intermediate transfer belt cleaning unit 9. The intermediate transfer belt cleaning unit 9 includes a cleaning blade that comes into contact with the intermediate transfer belt 7 to remove the residual toner and a toner recovery portion that recovers the removed toner. A part that is in contact with the cleaning blade in the intermediate transfer belt 7 is supported by the driven roller 72.

### (Sheet Conveyance Path and Peripheral Members Thereof)

As illustrated in FIG. 8, the sheet conveyance path S is communicated with the sheet discharge tray 15 from the paper feeding tray 10 and the manual paper feeding tray 20 through the fixing device 12 to be described later. Pickup rollers 16a and 16b, conveyance rollers 25a to 25f (hereinafter, the numerals are unified by the numeral 25), a registration roller 14, a transfer roller 11, and a fixing device 12 are disposed around the sheet conveyance path S. The conveyance roller 25 is a small-size roller in order to promote and assist the sheet conveyance, and plural pairs of conveyance rollers 25 are provided along the sheet conveyance path S. The pickup roller 16a is provided in the end part of the paper feeding tray 10, and the pickup roller 16a is an attraction roller that supplies the sheet-like recording medium (recording sheet) one by one from the paper feeding tray 10 to the sheet conveyance path S. The pickup roller 16b is provided near the manual paper feeding tray 20, and the pickup roller 16b is an attraction roller that supplies the recording medium one by one from the manual paper feeding tray 20 to the sheet conveyance path S. The registration roller 14 tentatively retains the recording medium conveyed through the sheet conveyance path S, and the registration roller 14 conveys the recording medium to the transfer device at the time the leading end of the toner image on the intermediate transfer belt 7 is aligned with the leading end of the recording medium.

### [Fixing Device Accommodation Portion]

As illustrated in FIG. 8, the fixing device 12 accommodated in the fixing device accommodation portion 100B includes a heat roller 81 and a pressure roller 82, which rotate mutually reversely while the recording medium to which the toner image is transferred is interposed therebetween, a conveyance roller 25b, and a sheet discharge roller 25c. The heat roller 81 is controlled by a controller (not illustrated) so as to become a predetermined fixing temperature. The controller controls the temperature at the heat roller 81 based on a detection signal from a temperature detector (not illustrated). The heat roller 81 that is raised to the fixing temperature and the pressure roller 82 are pressed against the recording medium to melt the toner, thereby fixing the toner image on the recording medium. The recording medium to which the toner image is fixed is conveyed to an inversion sheet discharge path of the sheet conveyance path S by the conveyance roller 25b and the sheet discharge roller 25c, and the recording medium is discharged onto the sheet discharge tray 15 while inverted (in the state in which the toner image is oriented downward).

### <Toner Cartridge of Fourth Embodiment>

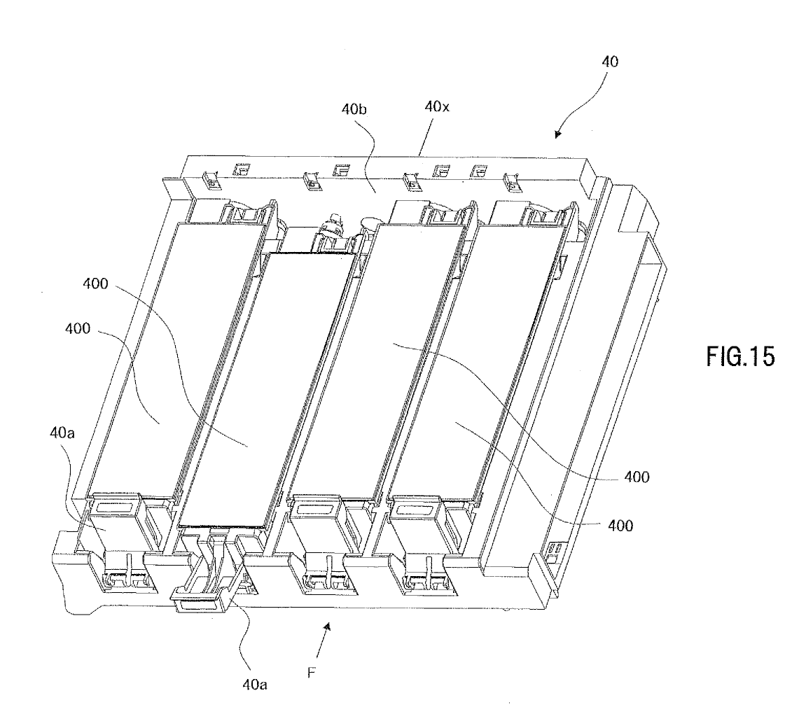

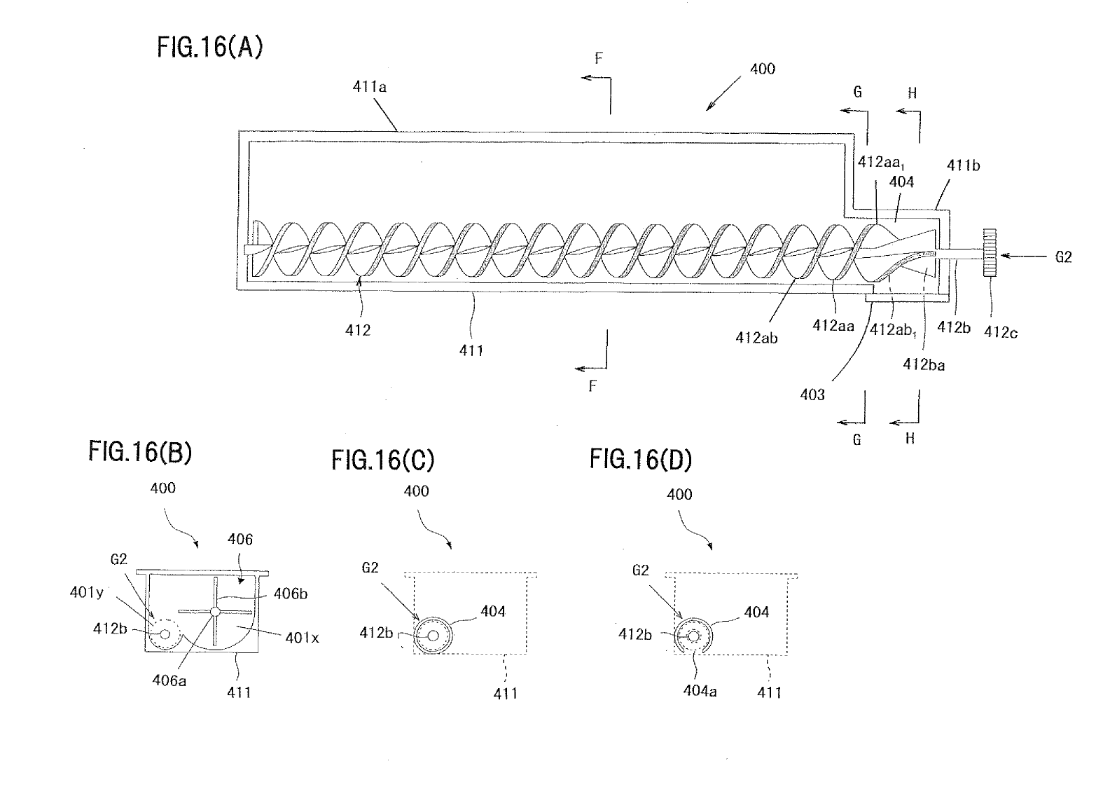

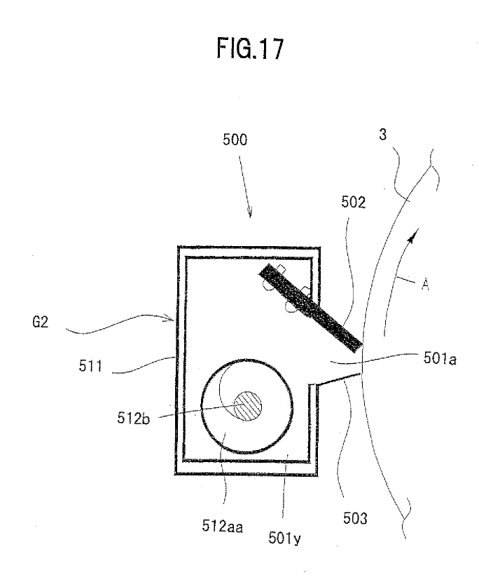

FIG. 15 is a perspective view illustrating a configuration of a toner cartridge unit that is provided with a toner cartridge according to a fourth embodiment of the present invention and loaded on the image forming apparatus of the third embodiment. FIG. 16A is a sectional side view of the toner cartridge of the fourth embodiment, FIG. 16B is a sectional view taken on a line F-F of the FIG. 16A, FIG. 16C is a sectional view taken on a line G-G of the FIG. 16A, and FIG. 16D is a sectional view taken on a line H-H of the FIG. 16A.

More particularly, the toner replenishment device 22 (see FIGS. 13 and 14) of the image forming apparatus of the third embodiment is replaced with a toner cartridge 400 of FIGS. 15 and 16. The toner cartridge 400 includes a cartridge body 411, the developer conveying device G2 (see FIG. 2) of the present invention that is provided in the cartridge body 411, and a paddle member 406. Specifically, the toner cartridge 400 includes the cartridge body 411, a shutter 403, a screw-shaped shaft 412, and the paddle member 406. The cartridge body 411 is formed into a unidirectionally-extended sealed container shape, and the cartridge body 411 has a toner discharge port 404a at one end side in the longitudinal direction thereof. The shutter 403 is provided on the outer surface side of the cartridge body 411 to open and close the toner discharge port 404a. The screw-shaped shaft 412 is provided in the cartridge body 411 while being rotatable about the longitudinal rotating shaft, and the screw-shaped shaft 412 is provided in the position in which the screw-shaped shaft 412 overlaps the toner discharge port 404a. The screw-shaped shaft 412 conveys the toner (not illustrated) in the cartridge body 411 to the toner discharge port 404a. The paddle member 406 includes a rotating shaft 406a that is parallel to a rotating shaft 412b of the screw-shaped shaft 412 in the cartridge body 411, and the paddle member 406 delivers the toner in the cartridge body 411 onto the side of the screw-shaped shaft 412.

In the toner cartridge 400, the cartridge body 411 includes a substantially rectangular solid part 411a and a projection part 411b that is continuously provided on one end side in the longitudinal direction of the substantially rectangular solid part 411a. In the cartridge body 411, one end of the rotating shaft 412b of the screw-shaped shaft 412 pierces a sidewall of the projection part 411b to project to the outside, and a gear 412c is loaded on one end of the rotating shaft 412b.

As illustrated in FIG. 15, the four toner cartridges 400 are loaded on a toner cartridge holder 40x side by side, thereby constituting a toner cartridge unit 40. The toner cartridge holder 40x has an upwardly-opened container shape. The toner cartridge holder 40x includes four recesses that are partitioned by partition walls, and the toner cartridges 400 are accommodated in the four recesses. A window in which the gear 412c of each toner cartridge 400 is inserted and a notch on which a lock lever 40a is oscillatably mounted are formed in wall portions on both sides in the longitudinal direction of the recess of the toner cartridge holder 40x. The toner cartridge 400 is fitted in the recess of the toner cartridge holder 40x, and the lock lever 40a of the toner cartridge holder 40x is upheld to move the cartridge body 411 to the right (direction of arrow F), whereby the toner cartridge 400 is maintained in the state in which the toner cartridge 400 is pressed against a stopper plate 40b of the toner cartridge holder 40x.

In a bottom wall of the recess of the toner cartridge holder 40x, a notch window (not illustrated) is formed from a position where the notch window faces the toner discharge port 404a of each loaded toner cartridge 400 to an end edge close to the position. In loading the toner cartridge unit 40 on the image forming apparatus, the toner cartridge 400 moves in the substantially horizontal direction with respect to the toner replenishment pipe 102 (see FIG. 9), whereby an end face of the shutter 403 abuts on an upper end of the toner replenishment pipe 102 passing through the notch window to move the shutter 403 in the substantially horizontal direction. When the toner discharge port 404a is disposed in the position where the toner discharge port 404a faces the toner replenishment pipe 102, the toner discharge port 404a is opened. A driving gear is provided in the image forming apparatus, and the driving gear engages a gear on the side of the paddle member 406 and a gear on the side of the screw-shaped shaft 412 of each toner cartridge 400 to transmit the torque from a driving motor.

The cartridge body 411 includes a toner storage portion 401x and a toner conveyance path 401y. The toner storage portion 401x is a large-volume space in which the paddle member 406 is disposed, and most of toners are stored in the toner storage portion 401x. The toner conveyance path 401y is a small-volume space in which the screw-shaped shaft 412 is disposed, and the toner conveyance path 401y is adjacent to the toner storage portion 401x while being communicated with the toner storage portion 401x, and the toner discharge port 404a is disposed on one end side in the longitudinal direction of the toner conveyance path 401y. A one-end part in the longitudinal direction of the toner conveyance path 401y is an internal space of the projection 411b of the cartridge body 411 and constitutes the toner discharge portion 404 including the toner discharge port 404a. That is, in the cartridge body 411, the toner conveyance path 401y is formed so as to project from the toner storage portion 401x toward one end side in the longitudinal direction, and the toner discharge port 404a is disposed in the projection space of the toner conveyance path 401y. The projection projects from the toner storage portion 401x toward one end side in the longitudinal direction. Bottom surfaces of the toner storage portion 401x and the toner conveyance path 401y are formed into arc shapes.

The toner discharge port 404a is a quadrangular opening provided in a bottom portion of the toner discharge portion 404, and the toner discharge port 404a is a downstream opening through which the toner conveyed by the screw-shaped shaft 412 is discharged to the outside of the toner cartridge 400. The shutter 403 has a substantially quadrangular plate shape, and the shutter 403 is slidably provided in the position where the toner discharge port 404a is closed. The shutter 403 opens the toner discharge port 404a when the toner cartridge 400 is loaded on the image forming apparatus. Before the toner cartridge 400 is loaded on the image forming apparatus, for example, a spring member (not illustrated) snap-biases the shutter 403 in the direction in which the toner discharge port 404a is closed.

The paddle member 406 includes a rotating shaft 406a and one rectangular agitating blade 406b that is mounted on the rotating shaft 406a. One end of the rotating shaft 406a rotatably pierces a sidewall on one end side in the longitudinal direction of the cartridge body 411 of the toner storage portion 401x, and a gear (not illustrated) is mounted on one end of the rotating shaft 406a. The other end of the rotating shaft 406a is supported while being journaled in a recess provided in a sidewall on the other end side in the longitudinal direction of the cartridge body 411 of the toner storage portion 401x.

The agitating blade 406b includes a flexible sheet member, such as a resin sheet (for example, PET sheet) and a rubber sheet, which has both proper flexibility and rigidity. The agitating blade 406b is slightly shorter than the toner storage portion 401x, and the agitating blade 406b has a width that slides on or comes close to the bottom surface of the toner storage portion 401x. When the rotating shaft 406a rotates, the agitating paddle 406 separates the toners in the toner storage portion 401x and takes up the separated toner to deliver the toner into the toner conveyance path 401y.

The toner conveying device G2 is integrated with the cartridge body 411 and incorporated as a part of the configuration of the toner cartridge 400. Referring to FIGS. 2 and 16, the toner conveying cylinder 111B of the toner conveying device G1 corresponds to the surrounding wall portion of the screw-shaped shaft 412 in the cartridge body 411, the screw-shaped shaft 112 corresponds to the screw-shaped shaft 412, the toner introduction port of the toner conveying device G1 corresponds to the communication part located at a boundary of the toner conveyance path 401y and the toner storage portion 401x, and the downstream opening 111d corresponds to the toner discharge port 404a.

Accordingly, the toner cartridge 400 includes the toner conveying device G2, the cartridge body 411 that is disposed adjacent to the toner conveying device G2 to include the toner storage portion 401x, the shutter 403 that is provided on the outer surface side of the cartridge body 411 to open and close the toner discharge port 404a, and the paddle member 406 that is rotatably provided in the cartridge body 411 to deliver the toner in the toner storage portion 401x from the toner introduction port into the toner conveyance path 401y. In FIG. 16, the numerals 412aa and 412ab designate spiral blades, the numerals 412aa₁ and 412ab₁ designate agitating blade portions, the numeral 412ba designates a conical portion, and the numeral 412c designates a gear.

### [Working Effect of Toner Cartridge]

The toner cartridge 200 is loaded on the image forming apparatus to open the shutter 203, and the toner discharge port 404a and the toner replenishment pipe 102 are communicated with each other. In driving the image forming apparatus, the paddle member 406 rotates to deliver the toners in the toner storage portion 401x to the toner conveyance path 401y such that the toners are raked while being separated, and the screw-shaped shaft 412 rotates to deliver the toners in the toner conveyance path 401y to the toner discharge portion 404, whereby the toners are replenished from the toner discharge port 404a to the development device 2 through the toner replenishment pipe 102 (see FIG. 8).

At this point, before the toner cartridge 400 is used, sometimes a toner aggregation or a toner cluster exists on the side of the toner discharge portion 404. However, the toner aggregation in the toner discharge portion 404 is separated to recover the fluidity by the action of the agitating blade portions 412aa₁ and 412ab₁ and the conical portion 412ba of the screw-shaped shaft 412, and the toner in the toner discharge portion 404 is smoothly pushed out from the toner discharge port 404a and replenished to the development device 2. Accordingly, the conditions that the toner abuts on the downstream wall surface of the toner conveyance path 401y to be pressed against the downstream wall surface and that the stress is applied to the toner to degrade the fluidity are suppressed, and a lock phenomenon of the screw-shaped shaft 412, generated by consolidation state of the toner in the toner discharge portion 404, is prevented to properly replenish the toner to the development device 2.

### (Cleaning Unit of Fifth Embodiment)

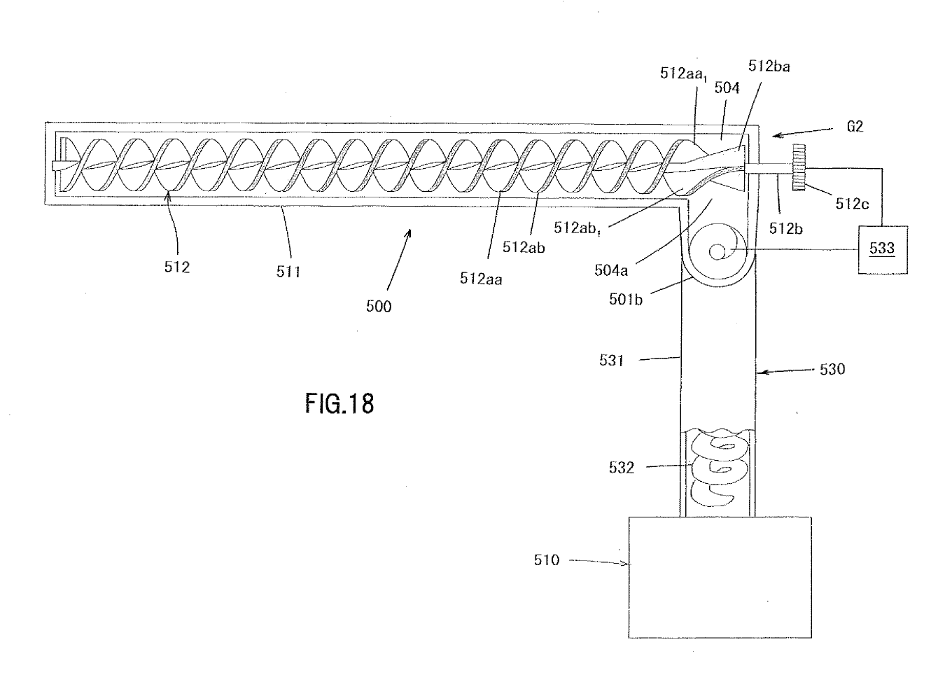

FIG. 17 is a schematic sectional view illustrating a configuration of a cleaning unit according to a fifth embodiment of the present invention mounted on the image forming apparatus of the third embodiment when being viewed from an upstream side, and FIG. 18 is a sectional view illustrating the cleaning unit of the fifth embodiment. More particularly, the cleaner unit 4 or the intermediate transfer belt cleaning unit 9 (see FIG. 8) of the image forming apparatus of the third embodiment is replaced with a cleaning unit 500 of FIGS. 17 and 18. The cleaning unit 500 includes the developer conveying device G2 (see FIG. 2), an upper blade member (cleaning blade) 502, and a lower blade member (waste toner anti-drop mylar) 503. The upper blade member (cleaning blade) 502 and the lower blade member (waste toner anti-drop mylar) 503 are mounted at opening edges of a toner introduction port 501 a in the developer conveying cylinder 511 of the developer conveying device G2. The cleaning unit 500 is connected to a waste toner recovery portion 510 with a relay conveying device 530 interposed therebetween.

The cleaning unit 500 removes a residual toner that is left in the surface of the photoconductor drum 3 after the transfer. The developer conveying device G2 provided in the cleaning unit 500 includes a toner conveyance path 501y therein, a toner discharge portion 504 that includes a toner discharge port 504a disposed on the downstream side of the toner conveyance path 501y and a substantially rectangular developer conveying cylinder 511 that includes a toner introduction port 501a opened onto the side of the photoconductor drum 3. The developer conveying device G2 also includes a screw-shaped shaft 512 that is rotatably provided in the developer conveying cylinder 511 to have the same configuration as the first embodiment. In FIGS. 17 and 18, the numerals 512aa and 512ab designate spiral blades, the numerals 512aa₁ and 512ab₁ designate agitating blade portions, the numeral 512b designates a rotating shaft, the numeral 512ba designates a conical portion, and the numeral 512c designates a gear.

The upper blade member 502 includes a rubber member having predetermined hardness. In order that the upper blade member 502 abuts on the surface of the photoconductor drum 3 to remove the residual toner, the upper blade member 502 is mounted on the toner conveying cylinder 511 by screws while being downwardly inclined toward a leading end side. The lower blade member 503 is made of a plastic material. In order that the lower blade member 503 receives the residual toner removed from the surface of the photoconductor drum 3 by the upper blade member 502 to introduce the residual toner to the developer conveyance path 501y, the lower blade member 503 is mounted on the developer conveying cylinder 511 while being upwardly inclined toward a leading end side. In FIG. 17, an arrow A indicates the rotation direction of the photoconductor drum 3.

The relay conveying device 530 includes a relay conveyance path 531, a coil spring 532 that is rotatably provided in the relay conveyance path 531, and a driving portion 533 that rotates the coil spring 532. The relay conveyance path 531 includes a flexible tube that communicates the toner discharge port 504a of the toner conveying device G2 and the waste toner recovery portion 510. More particularly, an L-shape connection cylindrical portion 501b that is communicated with the toner discharge port 504a is provided in a downstream end part of the toner conveying cylinder 511. A lower end of the connection cylindrical portion 501b is opened to an orientation orthogonal to the toner discharge port 504a and connected to the relay conveyance path 531. An end part on a conveyance upstream side of the coil spring 532 is disposed in the connection cylindrical portion 501b.

For example, the driving portion 533 of the relay conveying device 530 includes a cooperative shaft that pierces a sidewall of the connection cylindrical portion 501b to be pivoted on the connection cylindrical portion 501b, a rotating plate (not illustrated) that is fixed to an end part on the inside of the connection cylindrical portion 501b of the cooperative shaft, and a transmission gear (not illustrated) that transmits a torque of the rotating shaft 512b of the screw-shaped shaft 512 to the cooperative shaft. An end part on the upstream side in the conveyance direction of the coil spring 532 is coupled to the rotating plate. The waste toner recovery portion 510 includes an outside box that includes an upper connection port communicated with the downstream side in the conveyance direction of the relay conveyance path 531 and an upwardly-opened waste toner recovery box that is detachably mounted in the outside box.

In the cleaning unit 500 having the above-described configuration, a leading end of the upper blade member 502 that is in contact with the outer circumferential surface of the photoconductor drum 3 at a predetermined pressure flicks the residual toner, paper dust, and the like that adhere to the surface of the photoconductor drum 3 by utilizing a phenomenon (so-called “stick-slip phenomenon”) in which the leading end of the upper blade member 502 is flipped from the surface of the rotating photoconductor drum 3, and the residual toner and the like flicked by the lower blade member 503 are introduced into the developer conveying cylinder 511.

According to the cleaning unit 500 having the above-described configuration, the screw-shaped shaft 512 rotates to convey the waste toner, paper dust, and the like introduced into the developer conveying cylinder 511 to the toner discharge port 504a, thereby delivering the waste toner, paper dust, and the like into the relay conveying device 530. The lock phenomenon generated by the cluster of the waste toners in the toner discharge portion 504 of the cleaning unit 500 is prevented similarly to the fourth embodiment.

On the other hand, during the rotation of the screw-shaped shaft 512, the coil spring 532 also rotates in conjunction with the driving portion 533 of the relay conveying device 530, and the waste toner in the relay conveyance path 531 is conveyed in the relay conveyance path 531 by the rotating coil spring 532, whereby the waste toner drops in the waste toner recovery portion 510. For the waste toner (including the residual toner, the paper dust, and the like) recovered in the waste toner recovery portion 510, the waste toner recovery box is taken out from the outside box to dispose the waste toner, when a certain amount of waste toner is collected, after the cleaning unit 500 is driven for a predetermined time, or when regular maintenance is performed.

### Another Embodiment

The screw-shaped shaft 212 of the second embodiment (see FIG. 6) may be used instead of the screw-shaped shaft 112 in the developer conveying devices G1 of third to fifth embodiments.

1. A developer conveying device comprising:
a developer conveying cylinder that includes a developer conveyance path disposed therein while being extended in one direction, a toner introduction port disposed on an upstream side of the developer conveyance path to introduce a toner from an outside to the developer conveyance path, and a downstream opening opened in a direction orthogonal to the one direction on a downstream side of the developer conveyance path to circulate a developer containing at least the toner; and
a screw-shaped shaft that is rotatably provided in the developer conveying cylinder to convey the toner in the developer conveyance path from the upstream side to the downstream side,
wherein the screw-shaped shaft includes a rotating shaft that is journaled in an upstream wall portion and a downstream wall portion, which are included in the developer conveying cylinder, and a spiral blade that is mounted on an outer circumferential surface of the rotating shaft;
the rotating shaft includes a conical portion that thickens gradually toward the downstream side in a position where the rotating shaft faces the downstream opening; and
the spiral blade includes an agitating blade portion whose lead angle increases gradually toward the downstream side in a position where the spiral blade faces the downstream opening.

2. The developer conveying device according to claim 1, wherein the lead angle of the agitating blade portion increases continuously.

3. The developer conveying device according to claim 1, wherein the lead angle of the agitating blade portion has a maximum value of 90°.

4. The developer conveying device according to claim 1, wherein the conical portion includes a spiral groove in the outer circumferential surface thereof, and a spiral winding direction of the spiral groove is opposite to a spiral winding direction of the spiral blade.

5. The developer conveying device according to claim 1, wherein the spiral blade is a double spiral blade.

6. A development device to be mounted on an electrophotographic image forming apparatus including a photoconductor drum in which an electrostatic latent image is formed on a surface thereof, the development device comprising:
a developer tank that is integrally provided with the developer conveying device according to claim 1 including the developer conveyance path that is of a first developer conveyance path and the screw-shaped shaft that is of a first screw-shaped shaft, and a two-component developer containing a toner and a carrier being stored in the developer tank;
a second developer conveyance path that is disposed in the developer tank, the second developer conveyance path being parallel to the first developer conveyance path while being adjacent to the first developer conveyance path;
a second screw-shaped shaft that is rotatably provided in the second developer conveyance path; and
a development roller that is provided in the developer tank, the development roller rotating to supply the toner to a surface having the electrostatic latent image of the photoconductor drum while bearing the two-component developer,
wherein a downstream end of the first developer conveyance path is communicated with an upstream end of the second developer conveyance path through the downstream opening that is of a first communication path;
an upstream end of the first developer conveyance path is communicated with a downstream end of the second developer conveyance path through a second communication path;
the first and second screw-shaped shafts convey the developer in relatively reverse direction to cycle the developer in the developer tank; and
first and second screw-shaped shafts supply the developer to the development roller.

7. The development device according to claim 6, wherein the second developer conveyance path and the second screw-shaped shaft are included in the other one of the developer conveying device according to claim 1, and downstream openings of the other developer conveying devices act as the second communication path.

8. The development device according to claim 7, wherein the developer tank includes a backflow prevention thread portion in a bottom portion of at least one of the first and second communication paths, and the first and second screw-shaped shafts rotate in a direction in which outer circumferential portions of the spiral blades of the first and second screw-shaped shafts come close to the backflow prevention thread portion from below.

9. A toner cartridge comprising:
a cartridge body that includes the developer conveying device according to claim 1 and a toner storage portion that is disposed adjacent to the developer conveying device;
a shutter that is provided at an outer surface side of the cartridge body to open and close the downstream opening that is of a toner discharge port of the developer conveying device; and
a paddle member that is rotatably provided in the cartridge body to deliver the toner in the toner storage portion from the toner introduction port of the developer conveying device into the developer conveyance path.

10. A cleaning unit comprising:
the developer conveying device according to claim 1; and
a blade member that is mounted at an opening edge of the toner introduction port in the developer conveying cylinder of the developer conveying device.

11. An image forming apparatus comprising:
a photoconductor drum in which an electrostatic latent image is formed on a surface thereof;
a charging device that charges the surface of the photoconductor drum;
an exposure device that forms the electrostatic latent image on the surface of the photoconductor drum;
the development device according to claim 6 that supplies a toner to the electrostatic latent image on the surface of the photoconductor drum to form a toner image;
a toner replenishment device that replenishes the toner to the development device;
a transfer device that transfers the toner image on the surface of the photoconductor drum to a recording medium; and
a fixing device that fixes the toner image to the recording medium.

12. An image forming apparatus comprising:
a photoconductor drum in which an electrostatic latent image is formed on a surface thereof;
a development device that supplies a toner to the electrostatic latent image on the surface of the photoconductor drum to form a toner image;
the toner cartridge according to claim 9 that replenishes the toner to the development device;
a transfer device that transfers the toner image on the surface of the photoconductor drum to a recording medium; and
a fixing device that fixes the toner image to the recording medium.

13. An image forming apparatus comprising:
a photoconductor drum in which an electrostatic latent image is formed on a surface thereof;
a development device that supplies a toner to the electrostatic latent image on the surface of the photoconductor drum to form a toner image;
a transfer device that transfers the toner image on the surface of the photoconductor drum to a recording medium;
a fixing device that fixes the toner image to the recording medium;
a waste toner recovery portion; and
the cleaning unit according to claim 10 that is provided such that the blade portion abuts on the surface of the photoconductor drum,
wherein the residual toner left on the surface of the photoconductor drum after the transfer is removed by the cleaning unit and conveyed to the waste toner recovery portion.
